(19) United States
(12) Patent Application Publication
(10) Pub. No.: US 2010/0251246 A1
(43) Pub. Date: Sep. 30, 2010

(54) System and Method for Generating Job Schedules

(76) Inventor: Jesus Orlando II Gonzales, Foster City, CA (US)

Correspondence Address: AFS/ VISA, 666 THIRD AVENUE , 10TH FLOOR, NEW YORK, NY, 10017, US

(21) Appl. No.: 12/410,137

(22) Filed: Mar. 24, 2009

(51) Int. Cl. G06F 9/46

(52) U.S. Cl. 718/102

(57) ABSTRACT

A system and method for generating a test environment schedule containing an order of executing job control language (JCL) jobs in a test computing environment is provided. The system comprises a memory which stores a seed schedule containing a plurality of members having common JCL jobs appropriate for different test environments, with each member containing a plurality of JCL jobs in a predetermined order of execution. The memory also stores a parameter file containing parameters for modifying the seed schedule according to a specific test environment. The system also includes an environment schedule module executable by a processor and is adapted to convert the seed schedule to the test environment schedule to be executed in the specific test environment as specified in the stored parameter file.

### FIELD OF THE INVENTION

The present invention relates to scheduling jobs in a computing environment, and more particularly a system and method for efficiently scheduling jobs in a test bed computing environment.

### BACKGROUND OF THE INVENTION

Making modifications or enhancements to software running in a live computer system requires careful testing and deployment, especially if the system is a large transaction processing system such as VisaNet™, which processes over one hundred million financial transactions (e.g., credit card transactions) per day. Typically, a set of software modification projects are initially tested in a test environment which emulates the actual transaction processing system referred to as the ‘production’ system’.

In a production system, a number of programs or ‘jobs’ are executed in a specified order called a schedule. The production schedule, which lists a schedule of all the jobs used in production, is generally not used in test environments. However, to create schedules suited for every test environment manually would be tedious and error prone.

As shown in detail in FIG. 1, which is a block diagram of a system 100 for executing a schedule of jobs, a schedule 102 includes a plurality of members 104, 106, 108, 110, each of the members 104-110 including a plurality of JCL jobs (‘jobs’) ordered in a predetermined manner. In order to execute the jobs in the schedule, the members 104-110 are first individually loaded into an active environment 112. One or more of the jobs in the members 104, 106, 108 loaded in the active environment may include conditions 116, which are notifications that are issued when certain predetermined criteria have been met. The execution of a specific job may be an example of a criterion which may cause a notification to be issued, and the notification, in turn, may be a trigger to execute one or more jobs 118, so that there is a circular flow between the jobs and conditions as illustrated. In addition, system 100 includes rules 120 which are analogous to triggers. When certain of the rules 120 are activated by being loaded into rules status 122, loaded rules 124, 126 await trigger messages 130 which are strings issued by executed jobs 118, and upon receipt of the corresponding trigger messages 130 may, depending on the rule, load in a member of the schedule 102 into the active environment 112 or issue conditions 116.

The complex interaction between the components of system 100 allows for the execution of a complex test environment having numerous interrelated functions and operations. However, due to this complexity, when modifications are made and not adequately accounted for (e.g., when a condition that refers to a job is not updated to reflect a change in the job name), errors can cascade through the system 100. Therefore, when a new schedule is created for a test environment it is important that all of the features of the execution system 100 are updated and configured for the new test environment. Up to now, much of the required updating has been performed manually.

It would therefore be desirable to automate the process of generating job environment schedules appropriate for test environments and for updating all related components so that the environment schedules may be properly executed.

### SUMMARY OF THE DISCLOSURE

According to one aspect of the invention, a system for generating a test environment schedule containing an order of executing job control language (JCL) jobs in a test computing environment is provided. The system comprises a memory, processor and an environment schedule module executed by the processor. The memory stores a seed schedule containing a plurality of members having common JCL jobs appropriate for different test environments, with each member containing a plurality of JCL jobs in a predetermined order of execution. The memory also stores a parameter file containing parameters for modifying the seed schedule according to a specific test environment. The environment schedule module converts the seed schedule to the test environment schedule to be executed in the specific test environment based on the stored parameter file.

According to another aspect, the present invention provides a method for generating a test environment schedule containing an order of executing job control language (JCL) jobs in a test computing environment. The method comprises storing a seed schedule containing a plurality of members with each member containing a plurality of JCL jobs in a predetermined order of execution and for a plurality of different test environments. The method further comprises storing a parameter file containing parameters for modifying the seed schedule according to a specific test environment; and converting the seed schedule to the test environment schedule to be executed in the specific test environment based on the stored parameter file.

### BRIEF DESCRIPTION OF THE DRAWINGS

FIG. 1 is a block diagram of a known system for executing a schedule of jobs.

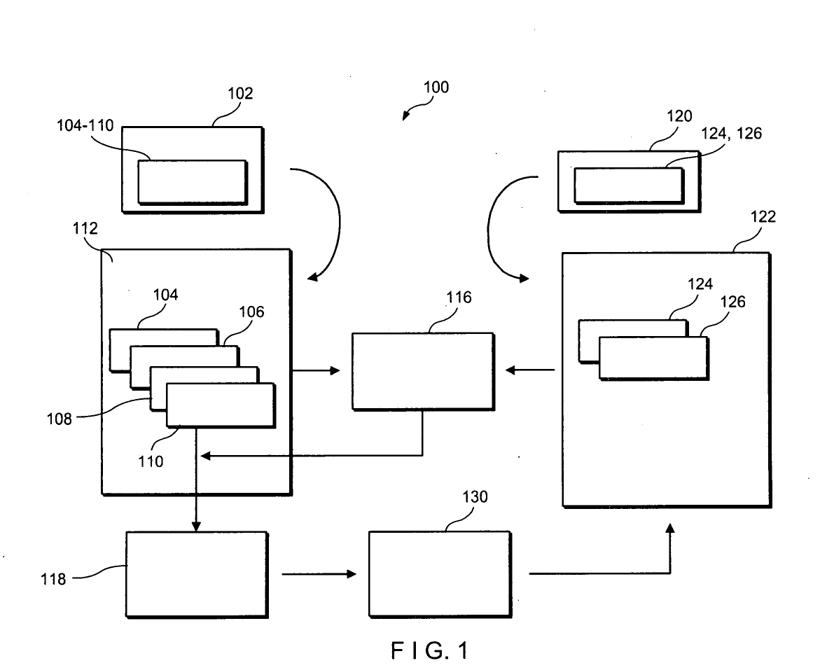

FIG. 2 is a block diagram of an exemplary system for generating a test environment schedule according to an embodiment of the present invention.

FIG. 3 is a block diagram of a computer system implementing an environment schedule module for generating a test environment schedule according to an embodiment of the present invention.

FIG. 4 is a flow chart of an exemplary method of generating a test environment schedule according to an embodiment of the present invention.

FIG. 5 illustrates the exemplary computer-based system of FIG. 8 in greater detail.

FIG. 6 shows an example user interface filter screen that allows a tester to filter the active environment based on group name.

### DETAILED DESCRIPTION OF THE INVENTION

For purposes of this application, the terms “code”, “program”, “application”, “software code”, “software module”, “module” and “software program” are used interchangeably to mean software instructions that are executable by a processor.

A “job” as defined herein is the program unit in the Job Control Language (JCL) for performing a particular task.

The present invention provides a system and method of converting a seed schedule, which contains ordered lists of all of the jobs that can be executed in a test environment, into an environment schedule, containing a subset of the ordered lists of jobs appropriate for the settings of a desired test environment. An environment schedule module generates the environment schedule by modifying the seed schedule based on settings in a parameter file which define the test environment.

The environment schedule module according to the present invention also converts seed rules, which contain all of the rules that may be used in executing a schedule, to environment test rules which contain rules for executing the environment schedule according to the settings contained in the parameter file. In addition, the environment schedule module changes the job names in all conditions contained in the jobs in the environment schedule and all rules contained in the environment test rules, and also changes a group name of all of the jobs so that the jobs in the environment schedule can be easily monitored during execution. The commands in the platform are automated using teleprocessor network simulator (TPNS) commands, and these commands are also unique to each platform, with a unique monitor identifier, so these TPNS commands inside the TPNS scripts are also updated by the environment schedule module.

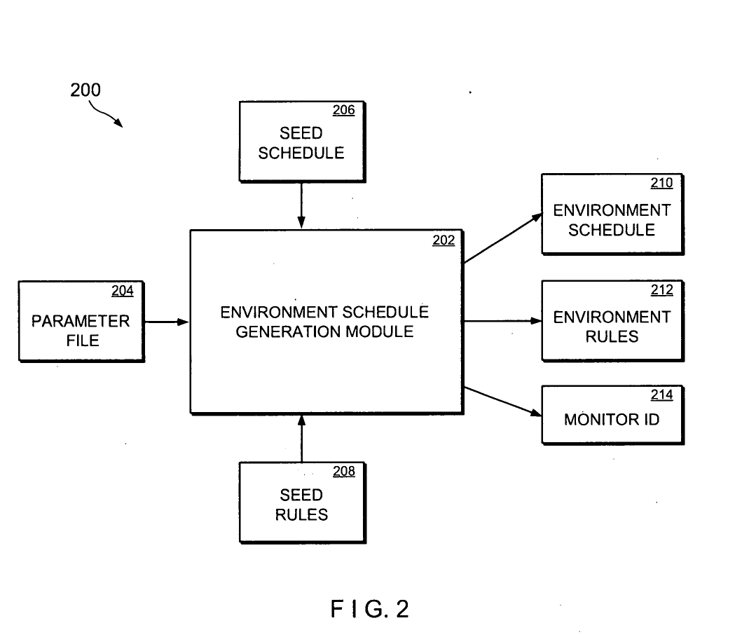

FIG. 2 shows an exemplary system 200 for generating a test environment schedule according to an embodiment of the present invention. An environment schedule module 202, which may be executed on a mainframe computer system is operative to receive or access a parameter file 204, which contains tester-defined settings appropriate for a desired test environment. Parameter file 204 includes a number of general settings such as an application identifier, an environment indicator, which indicates aspects of the computing environment being tested, a test name, a run date, and a job-name overlay which is used by environment schedule module 202 to keep all job name references consistent during a test. A section of an example parameter file is shown as follows:

APPLICATION-ID=QPA
ENVIRONMENT=RSI?
TESTNAME=BRP
RUN-DATE=CCYYMMDD
JOTT-JOBOVERLAY = R##4
VIC = OCE
LIBC1 =01-STG-PROD

In addition to the parameters described above, the section above includes a VIC setting which indicates the operating center being tested. The mainframe computer system may be in a network environment and may have several connected ‘processing centers’. The VIC setting may be used to set which of the operating centers are being simulated or tested in a given test procedure. Furthermore, the LIBC1 setting provides an order in which to search for files used for testing. In the example provided, in which LIBC1 is 01-STG-PROD, files will be searched first in a QA01 (Quality Assessment 01) directory. If the file sought is not found in the QA01 directory, the next directory search is the STG (stage) directory, which contains files in line to go into a live or production system. Lastly, if the file sought is not in the STG directory, then the PROD (production) library is used, which contains current production simulated schedules, is searched. An example of a file search is provided directly below.

The environment schedule module 202 receives or loads a seed schedule 206 that includes members which are tables that list related jobs in a specific order in which they are to be executed. The seed schedule 206 also includes a reference to the JCL library that contains the program code of listed jobs. Example tables included in seed schedule 206 include, among others, a CLEANUP table, which includes jobs for resetting the active environment, conditions and rules, GENLOGS tables that are used to generate logs, and a RECON table that reconfigures the active environment and test conditions in accordance with new test parameters. There are typically around fifteen (15) to twenty (20) different tables in seed schedule 206. However, since there are a plurality of different stored seed schedules, the correct stored seed schedule needs to be selected in order to generate the appropriate environment schedule for a test. The file name of the correct seed schedule is determined by settings in parameter file 204, particularly the VIC and LIBC1 parameters. Using the parameters in the example section above (VIC=OCE and LIBC1=01-STG-PROD), the seed schedule name may be ‘DPA.VOL.QA.IOA.OCE. SCHEDULE.QAO1’, where the OCE and QAO1 portions are taken from the VIC and LIB C1 parameters.

In addition to parameter file 204 and seed schedule 206, environment schedule also receives or loads seed rules 208 which includes records containing the base set of rules used in a test environment. Seed rules 208 may be found in a similar manner to the seed schedule 206 based on settings in parameter file 204.

From the inputs 204, 206, 208 it receives and/or loads, environment schedule module 202 generates the environment schedule 210, environment rules 212 and also generates monitor identifier 214. The environment schedule typically includes a subset of the tables included in seed schedule 206 as a number of tables may not be included in environment schedule 210 based on settings in parameter file 204. For example, parameter file may include a setting RECON=N (No), which indicates to the environment schedule module 202 that the RECON table should not be included in environment schedule 210. Similarly, environment rules 212 may include a subset of seed rules 208. In another example, if a parameter SYSPLEX, which is used to indicate whether dual mainframe processing is performed, is set to Y (Yes), then a set of rules ALLRULB1 or ALLRULEB are selected for environment rules 212, whereas if SYSPLEX is set to N (No), either ALLRULES or ALLRULE1 are selected instead. Another parameter ONERSI (which stands for one real-time settlement interface), is used to select between the respective ALLRULB1/ALLRULEB and ALLRULES/ALLRULE1. Thus, one of the main operations of environment schedule module 202 is to select only those portions of the seed schedule and seed rules appropriate for a test environment.

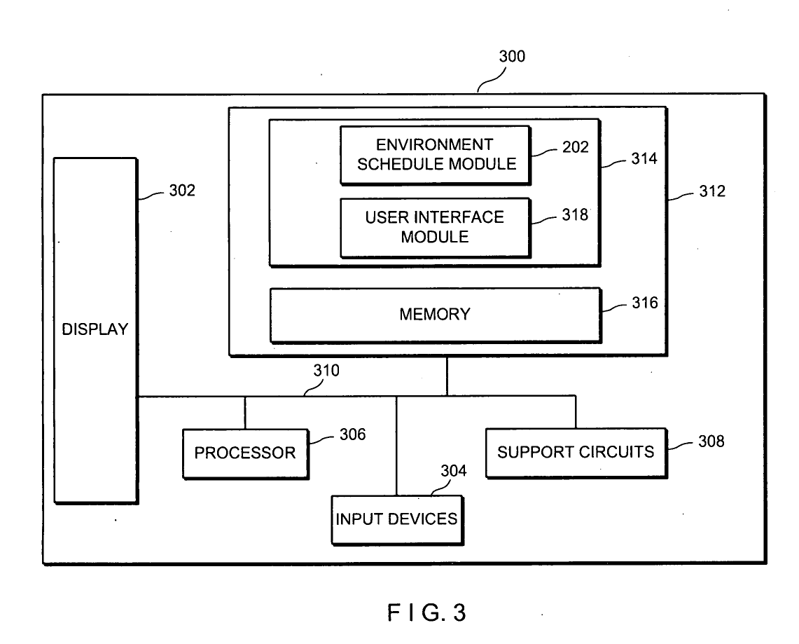

FIG. 3 is an exemplary block diagram of a computer-based system 300 that may be used to execute the environment schedule module 202 according to the present invention. Computer system 300 includes a display 302, one or more input devices 304 such as a keyboard, mouse or pointer, a processor 306, such as a central processing unit (CPU), and support circuitry 308. The display 302, input devices 304, processor 306, and support circuitry 308 are commonly connected to a bus 310 which also connects to a memory 312. Memory 312 includes program storage memory 314 and data storage memory 316.

Program storage memory 314 and data storage memory 316 may each comprise volatile (RAM) and non-volatile (ROM) memory units and may also comprise hard disk and backup storage capacity. Program storage memory 314 stores software program modules and associated data, and in particular stores the environment schedule module 202 according to the present invention. In some embodiments, program storage memory 314 may also store a user interface module 318 used for generating screen the provide information to or receive directions from a tester as explained further below. Data storage memory 316 stores the parameter file 204 and source files including the seed schedule 206, seed rules 208 and source JCL libraries containing the program code for all jobs.

It is to be appreciated that the computer system 300 may be any computer such as a mainframe, but may also comprise a personal computer, minicomputer, workstation, or a combination thereof. While the computer system 300 is shown, for illustration purposes, as a single computer unit, the system may comprise a group/farm of computers which can be scaled depending on the processing load and database size.

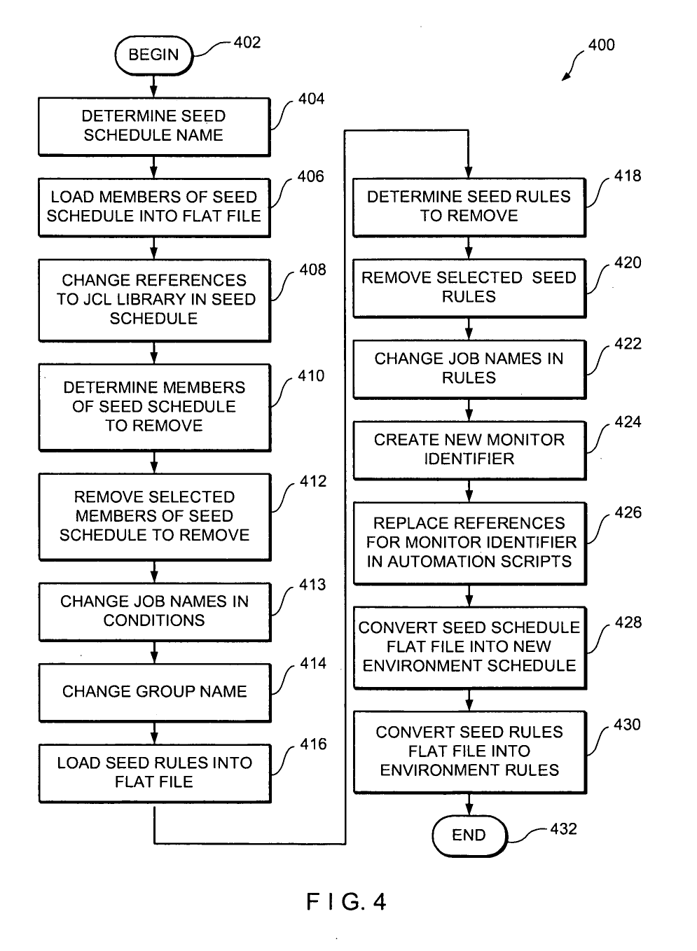

Referring to FIG. 4, which is a flow chart of an exemplary method 400 for generating a test environment schedule according to the present invention, all steps are executed by environment schedule module 202 unless otherwise indicated. The method begins in step 402, and in step 404, the seed schedule identifier (file name) is determined from parameter file 204. In step 406, the members of the seed schedule are opened and loaded in a ‘flat’ unformatted file. In the following step 408, all pointers or references to the JCL library in the seed schedule are changed to a new reference as determined by the APPLICATION-ID, ENVIRONMENT and TESTNAME settings in parameter file 204. In step 410, it is determined which members of the seed schedule may be removed based on the settings in parameter file 204, and in step 412, the determined members are removed from the flat file. For the members of the seed schedule 206 remaining, to avoid conflicts with other jobs that are not tailored for the test environment or that are used in production, in step 413 the job name identifiers in the flat file, including all references to job names in the conditions, are changed to new unique identifiers using the job overlay parameter (JOTT-JOBOVERLAY) in parameter file 204.

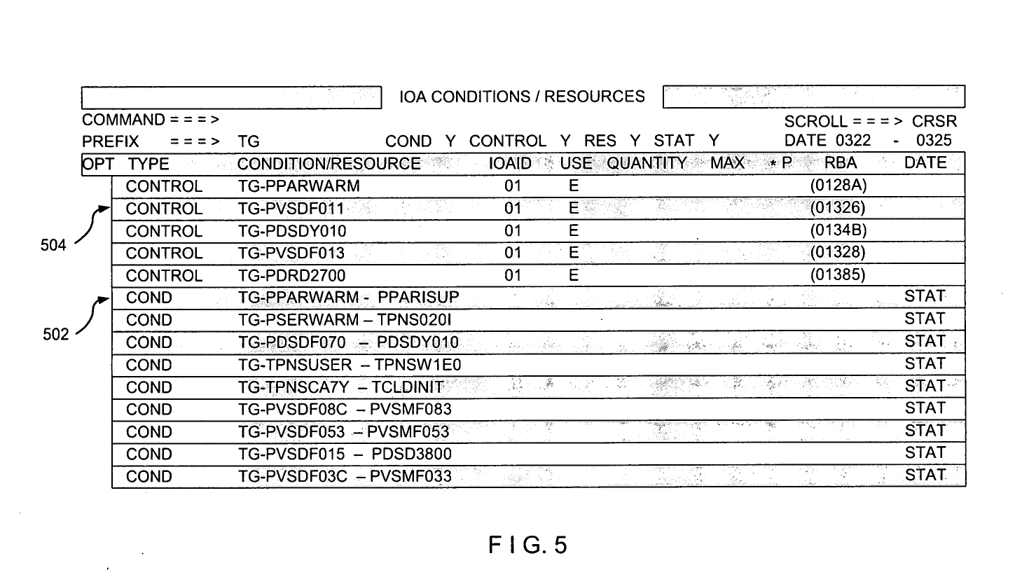

While there are numerous ways that the job identifiers in the conditions within the members of seed schedule 206 may be changed so that the new conditions have unique identifiers, in one embodiment, the two alphanumeric characters in the job overlay, which in the example section of parameter file 204 included above are “R” and “4”, are substituted for the first and fourth characters of the job identifier, respectively. For instance, according to this embodiment, for a job having a job name “PVSDSBMT”, the first character “P” is substituted with “R” and the fourth character “D” is substituted with “4”, and the name thus changes from “PVSDSBMT” to “RVS4SBMT”. The job overlay may be an abbreviation related to the environment parameter. For example, a job overlay “T##G” may designated a common environment DPA.TREG. Accordingly, every job name or condition having the letters “TREG . . . ” may be associated with a prefix “TG-”, which allows the tester to readily determine the unique environment associated with each job and condition. For example, the environment generation module 202 may generate and display a condition and resource screen on display 302 shown in FIG. 5, which illustrates example conditions for a schedule of jobs, such as the condition 502 named TG-PPARWARM-PPARISUP which provides the outputs of a job PPARWARM as input to the job PPARISUP.

By changing job names in this manner, redundancies in job names are removed, and thus no two modified job names in two different environments can be identical. In alternative embodiments, characters in a job name instead of and/or in addition to the first and fourth characters can be replaced, provided that each character being replaced is not significant to the testing environments, such as the second and third characters in certain test environments.

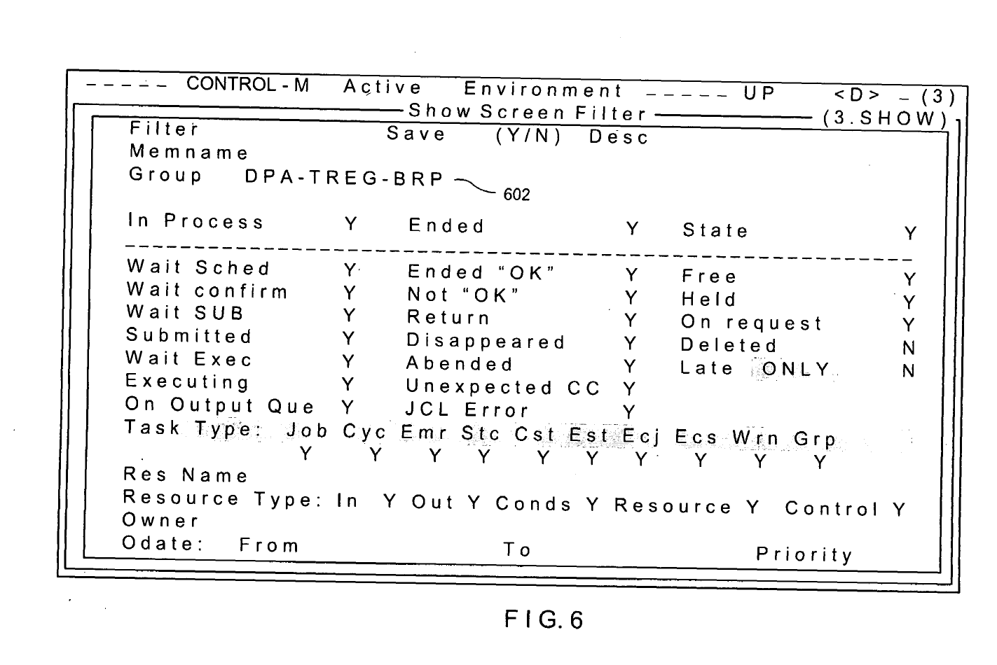

Returning again to the flow chart of FIG. 4, after the job name identifiers in the flat file have been changed, in step 414, the group name, which is an identifier included for every job listed in the members of the seed schedule is updated to reflect the new test environment. More specifically, the group name is set to a concatenation of the settings for parameters APPLICATION-ID, ENVIRONMENT and TESTNAME in parameter file 204. FIG. 6 shows a filter screen that allows a tester to filter the active environment based on group name, and to send the filtered group (only) to the scheduler for execution. As shown, the exemplary group name 602 used as a filter is DPA-TREG-BRP, which indicates that in this case the APPLICATION-ID is DPA, the environment is TREG and the TESTNAME is BRP (unlike the data shown in the section of parameter file 204 listed above).

Once the changes are made to the job names and group names in seed schedule 206 in the flat file, a similar process is performed for the seed rules 208. Accordingly, in step 416, the seed rules are copied onto another flat file (‘seed rule flat file’), and in step 418, it is determined which members of the seed rules 208 may be removed based on the settings in parameter file 204. The determined rules are removed from the seed rules flat file in step 420, and in step 422, the corresponding job names identifiers in the seed rules 208 are changed to new unique identifiers using the job overlay parameter as described above. Referring again to FIG. 5, a list of controls, which are equivalent to rules, is shown. One of the controls 504 is named TG-PVSDF011 which is applied to a job named PVSDF011 and includes the “TG” abbreviation for the environment “TREG” similar to condition 504.

Once the seed rules 208 in the seed rule flat file have been modified, in step 424, a similar process is performed on the seed TPNS scripts 214. Accordingly, an environment TPNS script is created for test, in order to make sure that no other tester (having a different monitor identifier) can alter the modifications made for the given test. In step 426, all instances of the corresponding parameter in certain automation scripts are replaced with the new monitor ID. Once the environment schedule module has performed all relevant modifications, in step 428, the seed schedule flat file is closed and the new environment schedule is created 210 (using a process reverse to that used to create the flat file), and in step 430, the seed rule flat file is also closed and converted into the environment rules 212. Consequently, the same is done on the TPNS scripts. It is understood that the order certain steps may be changed, and that, for example, the seed schedule flat file may be modified and converted prior to any operating on the seed rules 208. The method ends in step 432.

The foregoing specific embodiments represent just some of the ways of practicing the present invention. Many other embodiments are possible within the spirit of the invention. Accordingly, the scope of the invention is not limited to the foregoing specification, but instead is given by the appended claims along with their full range of equivalents.

What is claimed is:

1. A system for generating a test environment schedule containing an order of executing job control language (JCL) jobs in a test computing environment, the system comprising:
a memory storing:
a seed schedule containing a plurality of members with each member containing a plurality of JCL jobs in a predetermined order of execution, the seed schedule containing common JCL jobs for a plurality of different test environments; and
a parameter file containing parameters for modifying the seed schedule according to a specific test environment;
a processor coupled to the memory; and
an environment schedule module executable by the processor and adapted to convert the seed schedule to the test environment schedule to be executed in the specific test environment based on the stored parameter file.

2. The system of claim 1, wherein the parameters in the stored parameter file indicate which of the plurality of members to include in or exclude from the test environment schedule.

3. The system of claim 1, wherein:
the memory further stores a seed rule file for issuing triggers during execution of the JCL jobs contained in the test environment schedule when preset criteria are met; and
the environment schedule module converts the stored seed rule file to a test rule file based on the stored parameter file.

4. The system of claim 1, wherein:
the memory further stores a TPNS seed script file for automating commands in test computing environment, the TPNS seed script file having a monitor identifier; and
the environment schedule module is adapted to modify the monitor identifier in the TPNS seed script file based on the stored parameter file.

5. The system of claim 3, wherein the parameter file includes a job overlay setting for changing the names of JCL jobs included in the seed rule file, and the environment schedule module is adapted to parse the rules in the seed rule file to determine names of JCL jobs and to change the names of the JCL jobs using the job overlay setting.

6. The system of claim 5, wherein one or more of the plurality of JCL jobs in the seed schedule includes a condition containing instructions for issuing a notification when a preset criterion is met and including a name of an associated JCL job, and the environment schedule module is adapted to parse the condition to determine the name of the associated JCL job, and to change the name of the JCL job using the job overlay setting.

7. The system of claim 1, wherein the environment schedule module is further adapted to associate a unique group name to all of the jobs included in the environment schedule.

8. A method for generating a test environment schedule containing an order of executing job control language (JCL) jobs in a test computing environment, the method comprising:
storing a seed schedule containing a plurality of members with each member containing a plurality of JCL jobs in a predetermined order of execution, the seed schedule containing common JCL jobs for a plurality of different test environments;
storing a parameter file containing parameters for modifying the seed schedule according to a specific test environment; and
converting the seed schedule to the test environment schedule to be executed in the specific test environment based on the stored parameter file.

9. The method of claim 8, wherein the parameters in the stored parameter file indicate which of the plurality of members to include in or exclude from the test environment schedule.

10. The method of claim 8, further comprising:
storing a seed rule file for issuing triggers during execution of the JCL jobs contained in the test environment schedule when preset criteria are met; and
converting the stored seed rule file to a test rule file based on the stored parameter file.

11. The method of claim 8, further comprising:
storing a TPNS seed script file for automating commands in test computing environment, the TPNS seed script file having a monitor identifier; and
modifying the monitor identifier in the TPNS seed script file based on the stored parameter file.

12. The method of claim 10, wherein the parameter file includes a job overlay setting for changing the names of JCL jobs included in the seed rule file, and the method further comprises:
parsing the rules in the seed rule file to determine names of JCL jobs and to change the names of the JCL jobs using the job overlay setting.

13. The method of claim 12, wherein one or more of the plurality of JCL jobs in the seed schedule includes a condition containing instructions for issuing a notification when a preset criterion is met and including a name of an associated JCL job, and the method further comprises:
parsing the condition to determine the name of the associated JCL job, and to change the name of the JCL job using the job overlay setting.

14. The method of claim 8, further comprising:
associating a unique group name to all of the jobs included in the environment schedule.
